(19) United States
(12) Patent Application Publication
(10) Pub. No.: US 2016/0283947 A1
(43) Pub. Date: Sep. 29, 2016

(54) SHARING KNOWLEDGE ARTICLE CONTENT VIA A DESIGNATED COMMUNICATION CHANNEL IN AN ENTERPRISE SOCIAL NETWORKING AND CUSTOMER RELATIONSHIP MANAGEMENT (CRM) ENVIRONMENT

(71) Applicant: salesforce.com, inc., San Francisco, CA (US)

(72) Inventors: Eric Shu Wang Yip, San Francisco, CA (US); Jianming Shao, Fremont, CA (US); Ronald Liu, Seattle, WA (US); Spencer Scorcelletti, San Francisco, CA (US); Srinath Viswanathan, Fremont, CA (US); Zhongyu Ma, Millbrae, CA (US)

(21) Appl. No.: 14/669,691

(22) Filed: Mar. 26, 2015

(51) Int. Cl. G06Q 30/00; G06Q 50/00; G06F 17/30; H04L 12/58

(52) U.S. Cl. CPC G06Q 30/016; H04L 51/32; G06Q 50/01; G06F 17/30528; G06F 17/30525

(57) ABSTRACT

Disclosed are examples of systems, apparatus, methods and computer program products for sharing knowledge article content. In some implementations, a customer relationship management (CRM) record having a dedicated feed in a social networking system can be processed. A selection of a knowledge article can be received via a user interface. A communication channel can be identified. Selected knowledge article content of selected layout attributes corresponding to the identified communication channel can be inserted into a message. The message can be sent to a recipient device via the identified communication channel.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to knowledge articles. More specifically, this patent document discloses techniques for sharing knowledge article content.

### BACKGROUND

“Cloud computing” services provide shared resources, applications, and information to computers and other devices upon request. In cloud computing environments, services can be provided by one or more servers accessible over the Internet rather than installing software locally on in-house computer systems. As such, users having a variety of roles can interact with cloud computing services.

### BRIEF DESCRIPTION OF THE DRAWINGS

The included drawings are for illustrative purposes and serve only to provide examples of possible structures and operations for the disclosed inventive systems, apparatus, methods and computer techniques for sharing knowledge article content. These drawings in no way limit any changes in form and detail that may be made by one skilled in the art without departing from the spirit and scope of the disclosed implementations.

FIG. 1 shows a system diagram of an example of a database system 100 for sharing knowledge article content, in accordance with some implementations.

FIG. 2 shows a flow chart of an example of a method 200 for sharing knowledge article content, in accordance with some implementations.

FIG. 3 shows a flow chart of an example of a method 300 for sharing knowledge article content, in accordance with some implementations.

FIG. 4 shows an example of a user interface 400 in the form of a graphical user interface (GUI) as displayed on a computing device for mapping knowledge article layout attributes and communication channels, in accordance with some implementations.

FIG. 5 shows an example of a knowledge article 500 as displayed on a computing device, in accordance with some implementations.

FIG. 6 shows an example of a user interface 600 in the form of a GUI as displayed on a computing device for sharing knowledge articles, in accordance with some implementations.

FIG. 7 shows an example of a case window 700 in the form of a GUI as displayed on a computing device for sharing knowledge articles, in accordance with some implementations.

FIG. 8 shows an example of a retry window 800 in the form of a GUI as displayed on a computing device for attaching files to a message, in accordance with some implementations.

FIG. 9A shows a block diagram of an example of an environment 10 in which an on-demand database service can be used in accordance with some implementations.

FIG. 9B shows a block diagram of an example of some implementations of elements of FIG. 9A and various possible interconnections between these elements.

FIG. 10A shows a system diagram of an example of architectural components of an on-demand database service environment 900, in accordance with some implementations.

FIG. 10B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for sharing knowledge article content. As discussed herein, knowledge articles include electronic documents and other types of electronic data files containing or referencing information that may be of interest to various users. For example, in a customer relationship management (CRM) environment, knowledge articles describing an organization's products and/or services may be stored or identified in a CRM database of a database system maintained for the organization. For example, a knowledge article may be created and updated in a database system to collect useful information for customers regarding product specifications, warranty information, repair instructions, and other aspects of an organization's product and/or service line that the organization's customer base is likely to be interested in.

Since knowledge articles are often in the form of electronic files, knowledge articles can be electronically stored, shared and manipulated in various manners. For example, a knowledge article can be sent from a customer service representative of the organization to a customer by email. The email may be structured so a relevant portion of a lengthy knowledge article is embedded in the body of the email. Using some of the disclosed techniques, knowledge article content can be automatically retrieved and pasted into an email using a selection of custom article fields. This allows a user who receives the email to immediately access knowledge article content without having to access a database system or access a website.

In a conventional CRM environment, in response to a concern or issue from a customer, a customer service representative may have to manually paste in an email a uniform resource locator (URL) to an entire knowledge article accessible via a website. The knowledge article can contain content that resolves a concern, but often also contains a large volume of irrelevant content. By way of example, Alex is a customer service representative for Shipwright Shipping Company, a company specializing in the construction of ships and ship repairs. Shipwright has thousands of employees and thousands of customers. As a company of that size, it has thousands of customer concerns and issues. Over the years, Shipwright has addressed many identical customer concerns and issues on a repeated basis. Shipwright has created a knowledge base of knowledge articles to address such concerns for internal circulation, as well as knowledge articles for public circulation. Internally circulated knowledge articles can be used only by Shipwright employees, whereas publicly circulated knowledge articles can be made available to Shipwright customers, vendors, and others outside of the organization.

Alex is a productive employee and handles a large volume of customer concerns and issues each day. However, Shipwright has a conventional message sending system, which often results in inefficiencies in Alex's performance and inefficiencies in Shipwright's customer service as a whole. For example, Connie, an owner of several Shipwright ships has a problem with one of her ships; she needs to know why the engine won't start. Connie submits a description of her ship and the problem she is having on Shipwright's customer service page of Shipwright's website. Consequently, a case is created in a CRM database maintained by Shipwright. Alex is tasked to resolve the case that was created for Connie's problem. Alex may then manually search the Shipwright knowledge base for knowledge articles fitting the description that Connie provided. If Alex successfully finds the solution to Connie's problem in a knowledge article, then Alex could attach the knowledge article to an email to Connie or paste a URL into the body of the email, which may contain extraneous information.

Some of the disclosed techniques can be implemented to embed knowledge article content within the body of or as an attachment to an electronic communication such as an email, a text message, an instant message, or a social media message. By way of example, a graphical user interface (GUI) can be provided on a computing device that is configured to allow a user such as a customer service representative to create a mapping for articles of a specified type, as explained in greater detail below. An article type can have a label, name, and one or more communication channels assigned to it. Returning to the example discussed above, the knowledge article that Alex wants to send to Connie could be categorized as a type having the assigned communication channel of email. Thus, knowledge article content that Alex wishes to send to Connie can be embedded in the email.

In some implementations, each knowledge article stored or identified in a database system can be categorized as one or more of various types. Articles of a given type can have at least some of the same knowledge fields containing content. There can be numerous fields, even for articles of the same type. For example, a knowledge field can be a Title, Summary, Article Number, Question, or Answer. As such, for a given communication channel, a single field or subset of a large number of fields can be selected, such that content in the selected field(s) is included in a communication. Returning to the Shipwright example, the portion of the knowledge article that is most relevant to solving Connie's problem may reside in the Answer field of a knowledge article rather than in the Title, Summary, Article Number, and Question. For instance, Alex may choose to include Answer as a field for a specified communication channel and article type. Thus, as Alex is in the process of preparing an email to respond to Connie's problem, having email as the selected communication channel automatically causes the body of the email to be populated with only the content of the Answer field.

In some scenarios, a knowledge base can contain knowledge articles not available for public distribution. There can be situations where one knowledge article may contain some sensitive data that a company does not want to disclose to the public and may contain some public data suitable for public consumption. Being able to embed specified content from a knowledge article can address these concerns. For example, Shipwright may be working on a new design for a ship and have reached a point where they are planning a limited release of the new ship. They have also compiled a knowledge base of troubleshooting guides based on their internal testing of the new ship. However, they do not want to release all of the compiled content to the public just yet, as they would like to work out small problems before a general public release of the ship. Therefore, when a customer who is part of the limited release needs a question resolved, a Shipwright customer service representative may employ some of the disclosed techniques to selectively and automatically embed in a response only the information that can resolve the issue, limiting the amount of sensitive information sent externally.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

In some but not all implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

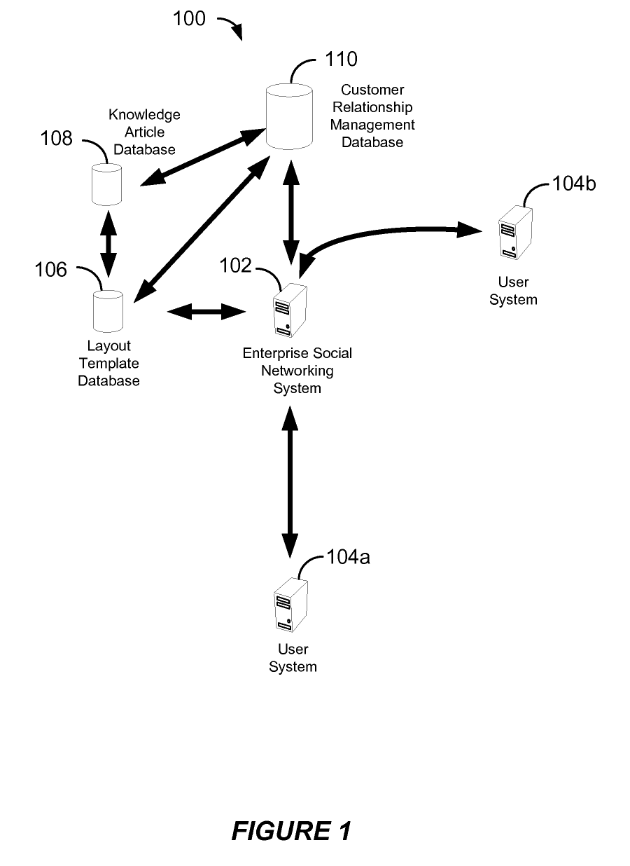

FIG. 1 shows a system diagram of an example of a database system 100 for sharing knowledge article content, in accordance with some implementations. Database system 100 may provide communications to be transmitted among a variety of different hardware and/or software components. In FIG. 1, database system 100 includes an enterprise social networking system 102 such as Chatter®, provided by salesforce.com, inc., user system 104a and user system 104b, layout template database 106, knowledge article database 108, and customer relationship management database 110. Communication among the various components may be facilitated through a combination of networks and internet connections.

Enterprise social networking system 102 can include any number of databases and servers. In some implementations, enterprise social networking system 102 may act as a communication intermediary between user system 104a, user system 104b, and the various databases of system 100. In some implementations, data sent to enterprise social networking system 102 from user system 104a may further be sent to layout template database 106, knowledge article database 108, customer relationship management database 110, or a combination thereof. In addition, user system 104b may receive the communication before or after being sent to one or more other components of database system 100. For example, user system 104a may send data used by enterprise social networking system 102 to create a layout template to store in layout template database 106. In response to this processing, enterprise social networking system 102 can furnish a message to be displayed on user system 104b.

Each of user systems 104a and 104b may be any type of computing device, which includes a display on which a user interface could be displayed. For example, user systems 104a and 104b may be portable electronic devices such as smartphones, tablets, laptops, wearable devices (e.g., smart watches), etc. User systems 104a and 104b may be desktop computers. Additionally, user systems 104a and 104b may be different types of computing devices. For example, user system 104a may be a desktop computer whereas user system 104b may be a smartphone.

In some implementations, layout template database 106 can be configured to receive, store, update, and otherwise maintain data from enterprise social networking system 102. Layout template database 106 can communicate with other databases in system 100. In some implementations, user system 104a can access layout template database 106 through enterprise social networking system 102. Enterprise social networking system 102 can access layout template database 106 without a request from user system 104a. Layout template database 106 can store layout templates, each of which can include communication channel layout fields and/or layout attributes. Layout templates can be linked with designated communication channels for sending a message. In addition, layout template database 106 can communicate with knowledge article database 108 and customer relationship management database 110 to create or modify a layout template stored in layout template database 106 using data provided by databases 108 and 110.

Knowledge article database 108 can receive, store, update, and otherwise maintain knowledge articles and related content to be used by enterprise social networking system 102. A knowledge article can contain and include references such as hyperlinks to content catered towards customer service personnel and customers, in some implementations. For example, a knowledge article can include a frequently asked question about a company's top selling product. In some implementations, a knowledge article can have different identifiable sections, for instance, organized under a hierarchy of headings and sub-headings, to organize various fields of the knowledge article. When a knowledge article is displayed in a user interface on a user's computing device, a knowledge article can have multiple different views, where each view corresponds to a different communication channel by which the knowledge article can be shared in a system and/or over a data network. Moreover, knowledge articles in the knowledge article database 108 can be organized hierarchically by type. Various filters can be applied to define types in the hierarchy.

Customer relationship management (CRM) database 110 can include various types of CRM records such as opportunities, accounts, leads, cases, contacts, contracts, etc. A database record such as a CRM record can be one instance of a data object, which may be a standard object or custom object provided by a cloud-based CRM service, in some implementations. In some implementations, customer relationship management database 110 can interact with enterprise social networking system 102 to generate a displayable feed with feed items reporting updates and online conversations about CRM records on user system 104a and user system 104b.

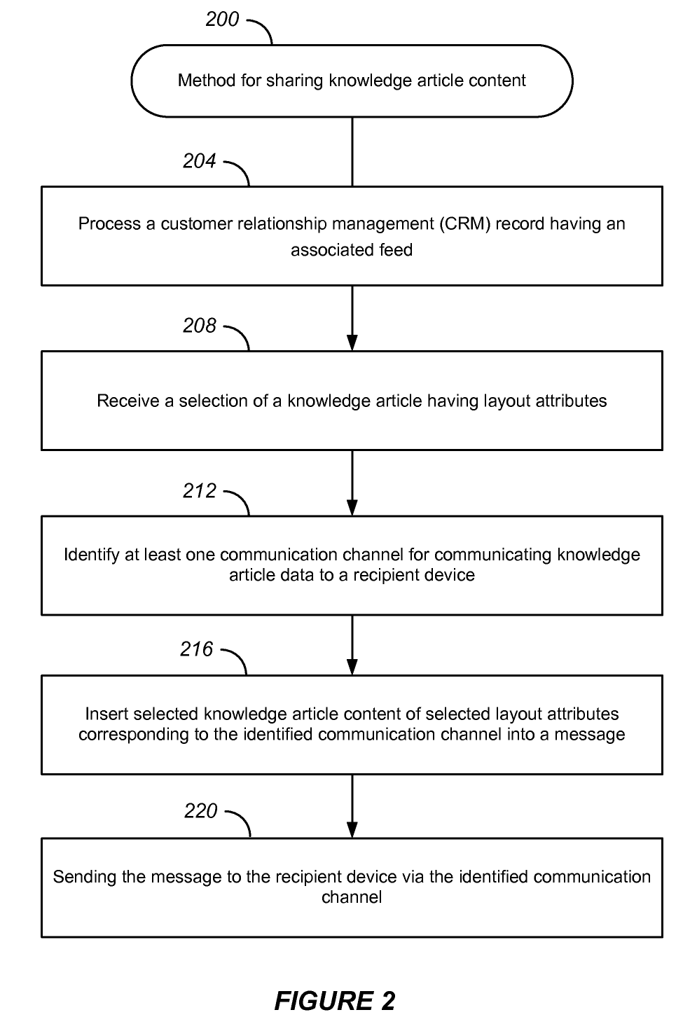

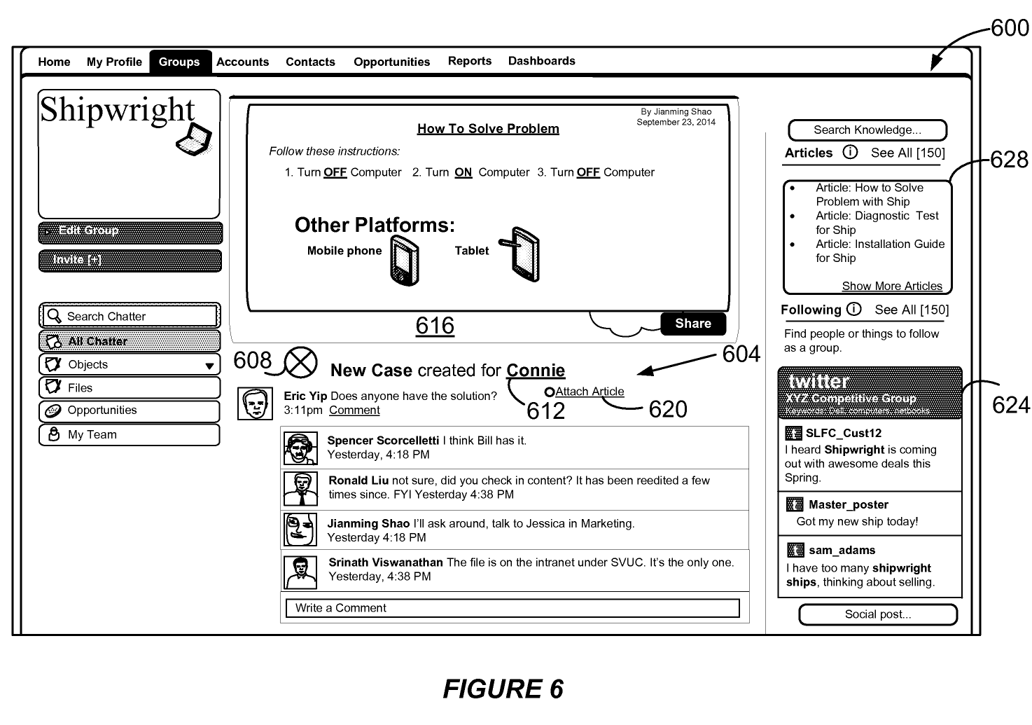

FIG. 2 shows a flow chart of an example of a method 200 for sharing knowledge article content, in accordance with some implementations. Method 200 and other methods described herein may be implemented using database system 100 of FIG. 1. In block 204 of FIG. 2, a CRM record is processed. The CRM record can have a dedicated feed configured to be displayed in conjunction with a publisher of a social networking system in a user interface on a user device. FIG. 6 shows an example of a user interface 600 in the form of a GUI as displayed on a computing device for sharing knowledge articles, in accordance with some implementations. For example, in FIG. 6, a feed 604 can be displayed as part of user interface 600. In this example, feed 604 is not dedicated to a particular CRM record, but rather is a group feed, that is, dedicated to a group of users named “Shipwright”. One or more CRM records can be stored in association with the Shipwright group and thus associated with feed 604.

In FIG. 6, feed 604 can display various types of information updates of interest to the Shipwright group, including but not limited to an update 608 informing users that a new case was created. Updates to CRM records stored in customer relationship management database 110 can be processed to be displayed in feed 604 by enterprise social networking system 102 of FIG. 1. In FIG. 6, a contact 612 named “Connie” is identified by a link in update 608. A user can click through the link to view Connie's contact information such as name, job title, organization, address, phone number, etc. stored in contact 612. In this example, a case was created for a problem Connie had. The update 608 is shared in the feeds of customer service representatives who are members of the Shipwright group. In FIG. 6, a publisher 616 is displayed with feed 604 in user interface 600. The publisher 616 can receive user input, for example, in the form of a post, comment, file attachment, URL, etc. and share that data on feed 604.

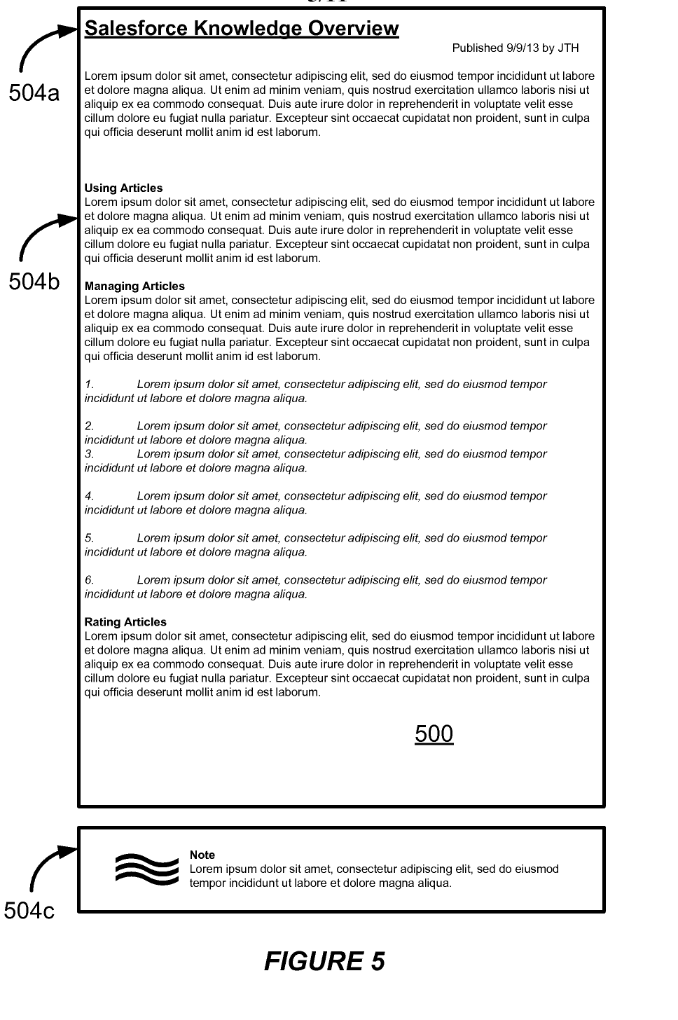

Returning to FIG. 2, in block 208, a knowledge article is selected by a user using a user interface such as that shown in FIG. 6. In some, but not all implementations, a knowledge article can be part of a knowledge base stored in knowledge article database 108 of FIG. 1. Knowledge articles can be added, edited, and removed from the knowledge base in a manner such that relevant and up-to-date information is maintained to benefit customer service representatives and users. FIG. 5 shows an example of a knowledge article 500 stored as part of a knowledge base as displayed on a computing device, in accordance with some implementations. Knowledge article 500 may be formatted and displayed to a user using HTML (HyperText Markup Language) and CSS (Cascading Style Sheets). Knowledge article 500 can be composed of different layout attributes 504a-c including a Title attribute 504a, heading attribute 504b, and a note attribute 504c. The layout attributes 504a-c can be organized in this or similar manners to define a structure and organization for knowledge article content. The content of the knowledge article can be formatted with rich text, which can include text, images, and other files. Moreover, the text of a knowledge article may be formatted with a variety of font types and colors with portions of text that can be underlined, bolded, and italicized. In addition, in some implementations hyperlinks can be included among other formatted rich text. A selection of knowledge article 500 can occur, for example, when a user clicks on article 500 in a list of articles in a knowledge sidebar 628 or clicks an “Attach Article” link 620 of FIG. 6.

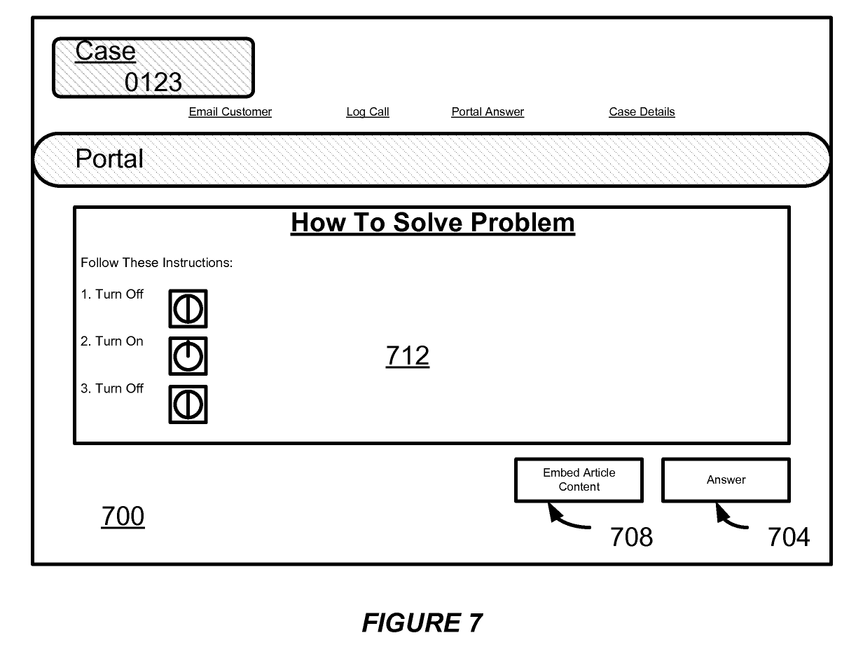

In another example for performing block 208 of FIG. 2, FIG. 7 shows a case window 700 in the form of a GUI as displayed on a computing device for sharing knowledge articles, in accordance with some implementations. The case window 700 includes an answer button 704 and embed article content button 708. In some implementations, case window 700 can be combined as part of user interface 600 or as a window overlaying user interface 600 of FIG. 6. As such, a user could select embed article content button 708 to select a knowledge article and communicate the selection to a server. In this way, selected article content can be linked with a CRM record such as Case 0123 in this example.

Returning to FIG. 2, in block 212, at least one communication channel can be identified for communicating knowledge article data to a recipient device. In some implementations, more than one communication channel may be identified.

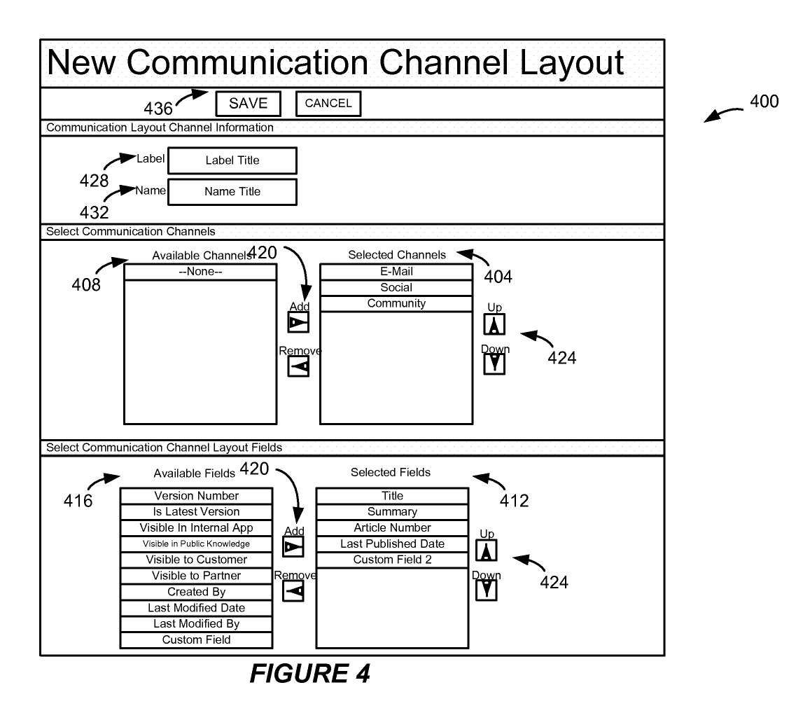

For example, FIG. 4 shows an example of a user interface 400 in the form of a GUI as displayed on a computing device for mapping knowledge article layout attributes and communication channels, in accordance with some implementations. Communication channels 404 can include, but are not limited to email, a publisher of a social networking system, other social networking communication options, instant messaging, text messaging, and community feeds or bulletin boards. In FIG. 4, a user can specify one or more communication channels for communicating knowledge article data to a recipient device.

For example, a social networking channel can be identified in FIG. 4. As an example, a social networking channel can include messaging to and possibly, though not necessarily, through social network systems external to enterprise social networking system 102 of FIG. 1. For example, Twitter® 624 of user interface 600 can be a communication channel identified for communicating knowledge article data to a recipient device. The recipient device could be operated by a Twitter® user.

In some implementations, a community channel can be identified, for instance, for communicating information to a group feed or a community feed. Groups can be public or private, and communities can include users external and/or internal with respect to an organization. For example, customer communities, partner communities, and employee communities can be defined for an organization. In some implementations, the communication channels that can be identified may depend on a knowledge article type. For example, some knowledge article types could have four channels that could be identified, whereas some other knowledge article type could have two channels that could be identified. Alternatively, some knowledge article types can have no available channels to be identified.

Returning to FIG. 2, in block 216, selected knowledge article content of selected layout attributes corresponding to the identified communication channel is inserted into a message. In some implementations, the selected knowledge article content can be generated dynamically within a publisher. In other words, the content generated within a channel can have rich text formatting that can be changed such that any changes made will be included in a message sent to the recipient device. In some implementations, the content can be inserted where a mouse cursor is currently hovering or where a text cursor last resided. For example, the content displayed in publisher 616 of FIG. 6 includes rich formatted text including images and fonts that are stylized and incorporate a particular layout, which can be maintained from the selected knowledge article. In another example, after a user selects the embed article content button 708 of FIG. 7, rich text formatting can be inserted into publisher 712, where it can be edited by a user. For example, superfluous knowledge article content can be removed. As such, knowledge article content, when sent as a message, can be different from the knowledge article from which it was derived. Alternatively, if the identified communication channel does not support rich text formatting, then unformatted text can be inserted.

In some implementations, the knowledge article content inserted into a publisher or other communication interface can be automatically determined by the selected layout attributes for a corresponding communication channel. In FIG. 4, selected communication channels 404 can be chosen from the available communication channels 408. For example, the selected communication channels 404 can include email, social (networking), instant messaging, and community. Also or alternatively, selected communication channels 404 can include the email communication channel, and available communication channels include email, social and community. In some implementations, selection of a communication channel can cause layout attributes unsupported by that channel to become unavailable for selection. In some implementations, a communication channel can be added or removed from either of the selected communication channels 404 and available communication channels 408. Additionally, these changes can be saved and stored on a database such as layout template database 106 of FIG. 1.

In FIG. 4, selected layout attributes can correspond to a communication channel. Selected fields 412 can include Title, Summary, Article Number, Last Published Date, and Custom Field 2, by way of example only. Selected fields 412 can correspond to selected communication channels 404. Available fields 416 can include Version Number, Is Latest Version, Visible in Internal App, Visible in Public Knowledge, Visible to Customer, Visible to Partner, Created By, Last Modified Date, Last Modified By, and Custom Field. In some implementations, additional and custom fields are included. In some implementations, the available fields 416 and selected fields 412 combined can correspond to a specific article type. In some implementations, a field can be added or removed from either of the selected fields 412 and available fields 416. Additionally, these changes can be saved and stored on a database such as layout template database 106 of FIG. 1.

In some implementations, selected layout attributes can be a selection from layout attributes of a particular knowledge article type. In some implementations, the selected layout attributes can be established initially for a knowledge article type to set up all knowledge articles of that type. Layout attributes can determine the type of content and appearance of a knowledge article. A complex knowledge article type can be made up of many layout attributes, while a simple knowledge article can have a single layout attribute. Many knowledge articles can have the same knowledge article type. Content may vary across the knowledge articles of the same knowledge article type.

In some implementations, a layout attribute can determine the rich text formatting of the content and can include files of various types. Also or alternatively, a layout attribute can include a text area containing rich text formatting. In some implementations, some selected layout attributes can be more suited for a particular communication channel. As such, the selected layout attributes corresponding to that communication channel can be appropriately selected for a knowledge article type. For example, a knowledge article type may have a layout attribute for internal company purposes only and, if that is the scenario, then the selected layout attributes can exclude the layout attribute for internal purposes for an email communication to be sent to a customer. A message including the knowledge article content can be sent to a recipient device, for example, user system 104b of FIG. 1. The message can be transmitted in a format deliverable to the recipient device. For any message being sent externally, an application programming interface can be used to facilitate that transmission.

Returning to FIG. 2, in block 220, the message to the recipient device is sent via the identified communication channel. In some implementations, the message sent to the recipient device can also be stored in the enterprise social networking system 102 in an appropriate database. In some implementations, the message can be displayed on the recipient device as it appeared on the device from which it was sent. Additionally, the message can be displayed according to the particular communication channel.

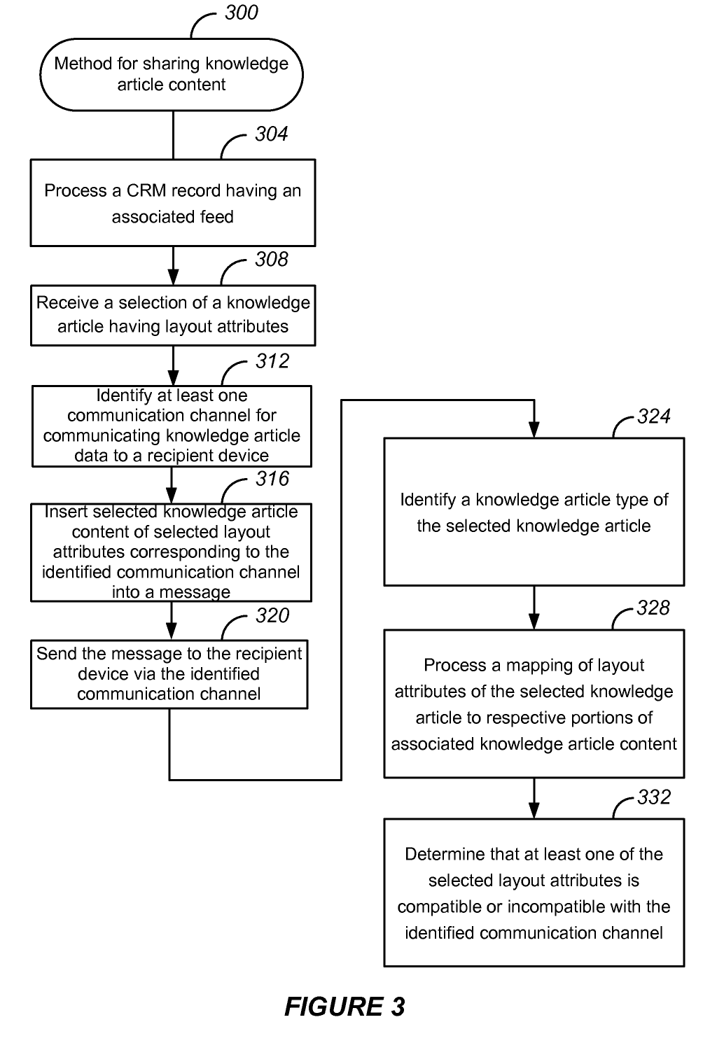

FIG. 3 shows a flow chart of an example of a method 300 for sharing knowledge article content, in accordance with some implementations. Blocks 304, 308, 312, 316 and 320 are implemented in similar fashion as corresponding blocks 204, 208, 212, 216 and 220 of FIG. 2. In block 324, a knowledge article type of the selected knowledge article is identified. For example, a user can access a user interface such as user interface 400 of FIG. 4. Next, an article type can be selected to designate an associated set of layout attributes. The user could then choose to create or edit, for example, a mapping as described in block 328. For example, in FIG. 4, selected fields 412 and available fields 416 along with selected communication channels 404 and available communication channels 408 can be arranged using navigation buttons 420 and 424. In some implementations, this arrangement can correspond to the layout of the fields to be displayed in a message. Label title 428 and name title 432 are fields which can receive customized text in order to classify the mapping.

Returning to FIG. 3, in block 328, a mapping of layout attributes of the selected knowledge article to respective portions of associated knowledge article content is processed. In some implementations, in order to create or edit within user interface 400, a user can have a permission set that enables the creation or editing of a mapping. For example, after changes have been made, a response from the save button 436 in FIG. 4 can process a mapping between layout attributes and knowledge article content of a selected knowledge article based on a derived knowledge article type. In some implementations, the mapping of the layout attributes to the respective portions of associated knowledge article content can be identified by data objects in layout template database 106 of FIG. 1. Also or alternatively, a data object that stored an original mapping can be updated to include changes to the mapping.

Returning to FIG. 3, in block 332, at least one of the selected layout attributes is determined to be compatible or incompatible with the identified communication channel. In some implementations, all of the selected layout attributes can be compatible with the identified communication channel. However, some or all layout attributes can be determined to not be compatible with a communication channel. For example, a knowledge article having file attachments can be incompatible if there is a file size limitation on the communication channel and the file attachments exceed that limitation. Where at least one selected layout attribute is determined to be incompatible with the identified communication channel, then a window can display in a user interface a selection of the files in the knowledge article and choice of which file or files to include in the message. A different layout attribute can then be selected. Also or alternatively, some layout attributes may only be capable of being displayed in certain communication channels. In such situations, a warning message could be displayed.

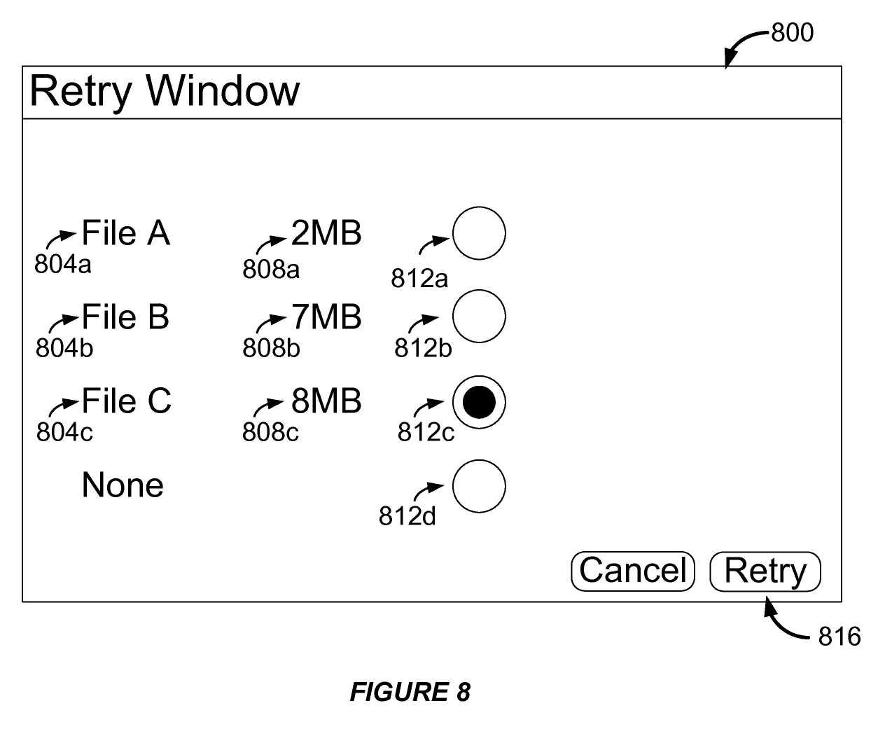

FIG. 8 shows an example of a retry window 800 in the form of a GUI as displayed on a computing device to illustrate attaching files to a message, in accordance with some implementations. Retry window 800 shows an example of what can be displayed when a selected layout attribute is incompatible with a communication channel. Retry files 804a-804c include File A, File B, and File C. Each retry file 804 can have a corresponding file size 808. For instance File A has a corresponding file size 808a of 2 MB, File B has a corresponding file size 808b of 7MB, and File C has a corresponding file size 808c of 8 MB. Also, each retry file 804 can have a retry selection 812. FIG. 8 shows the retry selection 812c being selected for File C, but in other implementations, more than one of the retry selections 812a-812c may be selected. Additionally, a retry selection 812d for no files to be sent in the message can be selected. Retry button 816 can be selected allowing a message with the retry file 816 to be sent to a recipient device.

Systems, apparatus, and methods are described below for implementing database systems and enterprise level social and business information networking systems in conjunction with the disclosed techniques.

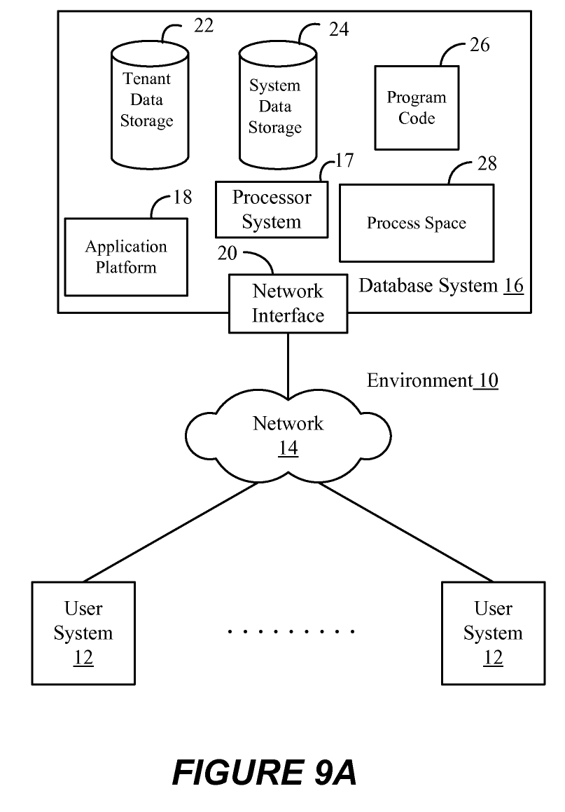

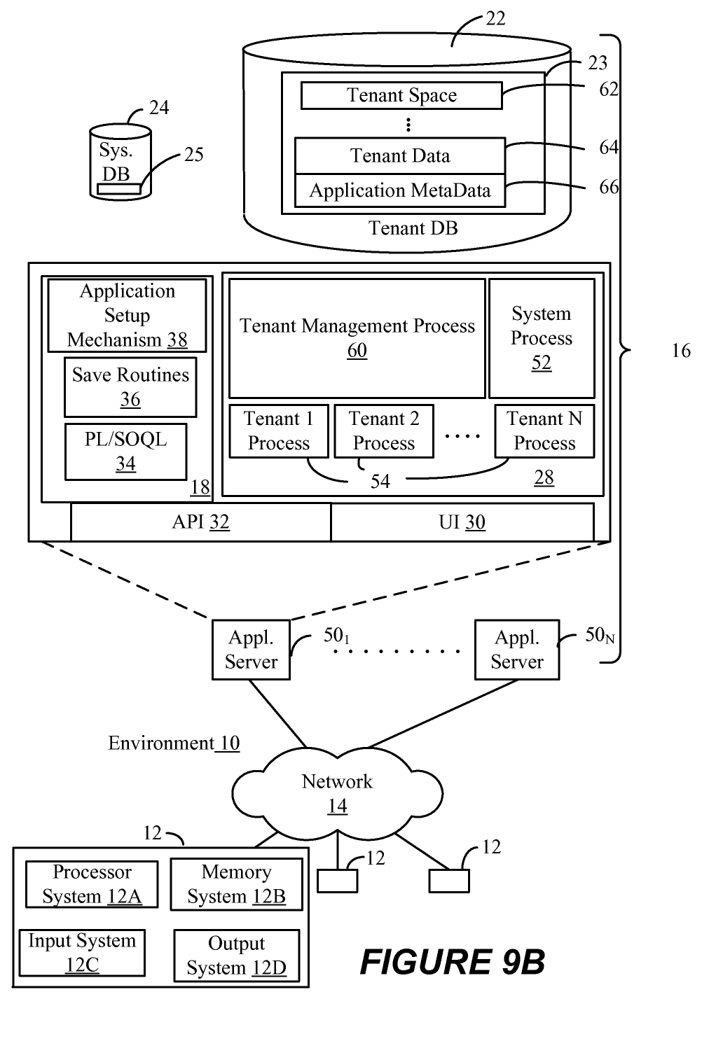

FIG. 9A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 9A (and in more detail in FIG. 9B) user systems 12 might interact via a network 14 with an on-demand database service, which is implemented in the example of FIG. 9A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS′ data; however, other alternative configurations may be used instead.

In one implementation, system 16, shown in FIG. 9A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 9A and 9B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 9A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (JavaTM is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 9B shows a block diagram of an example of some implementations of elements of FIG. 9A and various possible interconnections between these elements. That is, FIG. 9B also illustrates environment 10. However, in FIG. 9B elements of system 16 and various interconnections in some implementations are further illustrated. FIG. 9B shows that user system 12 may include processor system 12A, memory system 12B, input system 12C, and output system 12D. FIG. 9B shows network 14 and system 16. FIG. 9B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 9A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 9B, system 16 may include a network interface 20 (of FIG. 9A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

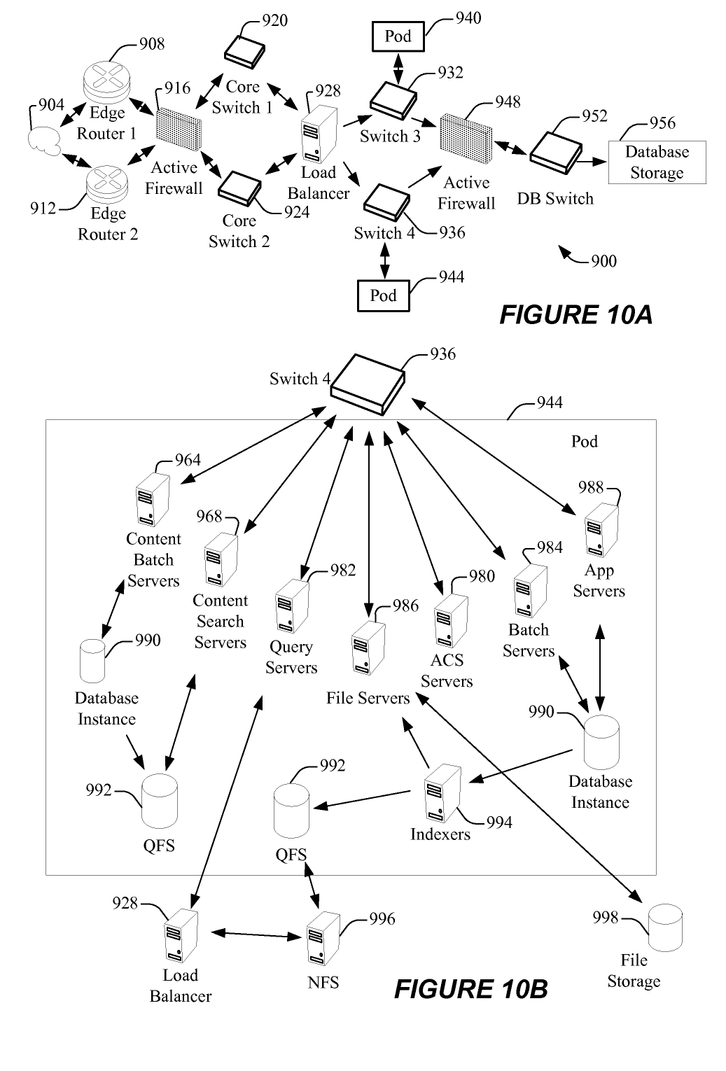

FIG. 10A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 10A and 10B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 10A and 10B, some implementations of an on-demand database service environment may include anywhere from one to many devices of each type. Also, the on-demand database service environment need not include each device shown in FIGS. 10A and 10B, or may include additional devices not shown in FIGS. 10A and 10B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 10B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 10A and 10B.

FIG. 10B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

Some but not all of the techniques described or referenced herein are implemented as part of or in conjunction with a social networking database system, also referred to herein as a social networking system or as a social network. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, Linkedln®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail herein.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described herein. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail herein, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned herein, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail herein. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system comprising:
at least one database storing a plurality of customer relationship management (CRM) records as data objects; and
at least one server having at least one processor capable of executing instructions configured to cause:
processing a CRM record in an enterprise social networking system implemented using the database system, the CRM record having a dedicated feed configured to be displayed in conjunction with a publisher in a user interface on a user device;
receiving a selection of a knowledge article via the user interface on the user device, the selected knowledge article having a plurality of layout attributes, each layout attribute having associated knowledge article content;
identifying at least one communication channel, the communication channel being for communicating knowledge article data to a recipient device;
inserting selected knowledge article content of selected layout attributes corresponding to the identified communication channel into a message configured to be sent to the recipient device via the identified communication channel; and
sending the message to the recipient device via the identified communication channel, the message capable of being displayed on the recipient device.

2. The database system of claim 1, the instructions further configured to cause:
identifying a knowledge article type of the selected knowledge article, the identified knowledge article type designating the selected layout attributes from the plurality of layout attributes of the selected knowledge article.

3. The database system of claim 2, the instructions further configured to cause:
processing a mapping of the plurality of layout attributes of the selected knowledge article to respective portions of associated knowledge article content, the mapping corresponding to the knowledge article type.

4. The database system of claim 3, the instructions further configured to cause:
storing or updating the mapping of the plurality of layout attributes to the respective portions of associated knowledge article content as at least one data object in the database of the database system.

5. The database system of claim 1, the instructions further configured to cause:
determining that at least one of the selected layout attributes is compatible or incompatible with the identified communication channel.

6. The database system of claim 5, the instructions further configured to cause:
providing for display, via the user interface on the user device, of at least one selected layout attribute determined to be incompatible with the identified communication channel; and
receiving at least one further selected layout attribute.

7. The database system of claim 1, wherein the CRM record is one of: a case, a lead, an opportunity, an account, a contact, or a contract.

8. The database system of claim 1, wherein the plurality of layout attributes include at least one of: a title, a summary, a date published, a last modified date, and a text area.

9. The database system of claim 8, wherein at least one of the plurality of layout attributes includes rich text formatting.

10. The database system of claim 1, wherein the identified at least one communication channel includes at least one of: an email channel, a community channel, an instant messaging channel, a publisher channel, or a social networking channel.

11. A method comprising:
processing a CRM record in an enterprise social networking system implemented using a database system including a CRM database storing a plurality of CRM records, the CRM record having a dedicated feed configured to be displayed in conjunction with a publisher in a user interface on a user device;
receiving a selection of a knowledge article via the user interface on the user device, the selected knowledge article having a plurality of layout attributes, each layout attribute having associated knowledge article content;
identifying at least one communication channel, the communication channel being for communicating knowledge article data to a recipient device;
causing selected knowledge article content of selected layout attributes corresponding to the identified communication channel to be inserted into a message configured to be sent to the recipient device via the identified communication channel; and
causing the message to be sent to the recipient device via the identified communication channel, the message capable of being displayed on the recipient device.

12. The method of claim 11, further comprising:
identifying a knowledge article type of the selected knowledge article, the identified knowledge article type designating the selected layout attributes from the plurality of layout attributes of the selected knowledge article.

13. The method of claim 12, further comprising:
processing a mapping of the plurality of layout attributes of the selected knowledge article to respective portions of associated knowledge article content, the mapping corresponding to the knowledge article type.

14. The method of claim 13, further comprising:
storing or updating the mapping of the plurality of layout attributes to the respective portions of associated knowledge article content as at least one data object in the database of the database system.

15. The method of claim 11, further comprising:
determining that at least one of the selected layout attributes is compatible or incompatible with the identified communication channel.

16. A computer program product comprising computer-readable program code to be executed by one or more processors when retrieved from a non-transitory computer-readable medium, the program code including instructions configured to cause:
maintaining, by at least one server, at least one database storing a plurality of customer relationship management (CRM) records as data objects;
processing a CRM record in an enterprise social networking system implemented using a database system including a CRM database storing a plurality of CRM records, the CRM record having a dedicated feed configured to be displayed in conjunction with a publisher in a user interface on a user device;
receiving a selection of a knowledge article via the user interface on the user device, the selected knowledge article having a plurality of layout attributes, each layout attribute having associated knowledge article content;
identifying at least one communication channel, the communication channel being for communicating knowledge article data to a recipient device;
inserting selected knowledge article content of selected layout attributes corresponding to the identified communication channel into a message configured to be sent to the recipient device via the identified communication channel; and
sending the message to the recipient device via the identified communication channel, the message capable of being displayed on the recipient device.

17. The computer program product of claim 16, the instructions further configured to cause:
identifying a knowledge article type of the selected knowledge article, the identified knowledge article type designating the selected layout attributes from the plurality of layout attributes of the selected knowledge article.

18. The computer program product of claim 17, the instructions further configured to cause:
processing a mapping of the plurality of layout attributes of the selected knowledge article to respective portions of associated knowledge article content, the mapping corresponding to the knowledge article type.

19. The computer program product of claim 18, the instructions further configured to cause:
storing or updating the mapping of the plurality of layout attributes to the respective portions of associated knowledge article content as at least one data object in the database of the database system.

20. The computer program product of claim 16, the instructions further configured to cause:
determining that at least one of the selected layout attributes is compatible or incompatible with the identified communication channel.
